(19) United States
(12) Patent Application Publication
(10) Pub. No.: US 2013/0073381 A1
(43) Pub. Date: Mar. 21, 2013

(54) MANAGED DISTRIBUTION OF BUSINESS PROMOTIONAL OFFERS TO CONSUMERS

(71) Applicant: Byron Binkley, Portland, OR (US)

(72) Inventor: Byron Binkley, Portland, OR (US)

(73) Assignee: MOBILIZEME, INC., Portland, OR (US)

(21) Appl. No.: 13/235,365

(22) Filed: Sep. 17, 2011

(51) Int. Cl. G06Q 30/02; G06Q 10/10

(52) U.S. Cl. 705/14.48; 705/14.61

(57) ABSTRACT

A system for managed distribution of business promotional offers, including a business-side interface for enabling each of a plurality of businesses to submit one or more definitions of promotional offers, each definition comprising at least one distribution constraint, and one or more scheduling constraints, a consumer-side interface for enabling each of a plurality of consumers to submit preferences for receiving promotional offers, a scheduler for deriving a schedule for distributing specific promotional offers to specific consumers at specific dates and times, in accordance with the distribution constraints, the scheduling constraints and the consumer preferences, and an event handler for invoking the scheduler in response to submissions by business and by consumers processed respectively by the business-side interface and the consumer-side interface. A method is also described and claimed.

### FIELD OF THE INVENTION

The present invention relates to business promotions offered to consumers.

### BACKGROUND OF THE INVENTION

Promotional offers are one of the most effective marketing tools used by businesses to attract new customers and to encourage loyalty of existing customers. There many factors that contribute to the efficacy of promotional offers. Some of these factors are (i) exclusivity and making an offer appear personal and special, (ii) consumer control of receipt of promotional offers, (iii) creating a sense of urgency and eliciting action of commitment, (iv) tracking user interaction with promotional offers and thus benefiting from analysis of success metrics, (v) scheduling tied to dates and times, (vi) scheduling tied to events, (vii) promotional offers tied to supply management, (viii) the ability to reward consumers with promotional offers based on historical engagement with a business, such as past purchases or making a referral, and (ix) relevance of promotional offers, including suggesting offers to specific consumers based on stated or inferred areas of interest.

Regarding exclusivity and making an offer appear personal and special, conventional approaches include, for example, direct business offers to individual consumers, typically in person, such as a bartender comps a round at a bar, or a proprietor reserves a table for a regular customer; or by way of a personal written letter or e-mail, e.g., a car salesman writes “Thank you for your business. I'd like to invite you back to get that special tire protection for just $99 this weekend.” These direct approaches implicitly communicate the exclusivity of the offer to consumers. Conventional approaches also include bulk business-to-consumer direct communications that include special offers, such as coupon codes, by way of an e-mail newsletter, a bulk text messaging program, or such other direct marketing channel, e.g., “Sign up for our [VIP text message list] [newsletter] [FACEBOOK® page] for special offers.” Conventional approaches also include mail merge techniques that enhance bulk communication relevance to make them appear personal, e.g., “Dear John Doe, we've selected you to receive this offer!” However, conventional approaches typically lose their ability to impart a sense of exclusivity as the number of recipients increases.

Regarding consumer control of receipt of promotional offers, conventional approaches include an opt in/opt out consumer choice for a single business that may span multiple product and offering categories. Conventional approaches also include consumer choice of interest categories to receive marketing literature.

Regarding creating a sense of urgency and eliciting action of commitment, conventional approaches include a short time period in which to act, e.g., “Memorial Day weekend sale only”. Conventional approaches also include promotions with limited quantities available, as stated in the promotional offer, e.g., “The next 10 callers will also get . . . ”

Regarding tracking user interaction and analysis of success metrics, conventional approaches include, for example, click-through tracking vs. advertising impressions. Conventional approaches also include response activations, e.g., “Click here by MM-DD-YYYY date to get your coupon.”

Regarding scheduling tied to dates and times, conventional approaches include manually scheduling promotions for a calendar date, or based on a fixed time interval, e.g., “every Monday, send out . . . ”

Regarding scheduling tied to events, conventional approaches include tying immediate promotions to consumer actions, e.g., “Check in on Facebook and get an instant $5 coupon for XYZ place.” Conventional approaches also include scheduling one or more promotions tied to events, e.g., after a customer signs up, sending out a series of promotions on the 2^{nd} day, 10^{th} day, etc. Conventional approaches also include tying promotions to consumer location as determined by a consumer action, e.g., checking in at a location via a smartphone, or by passive monitoring of location, by way of geo-perimeter to send SMS or push notifications, e.g., “There's a Starbucks around the corner, come in for a 50% off latte!”

Regarding promotional offers tied to supply management, conventional approaches include, as examples, a summer clearance sale, an airline automatically discounting prices based on supply and time to flight, and quantity controlled promotions based on times of the day such as GROUPON NOW®, a service of Groupon Inc. of Chicago, Ill.

Regarding the ability to reward consumers with promotional offers based on historical engagement with a business, conventional approaches include loyalty programs with rewards tied to purchase frequency or quantity. Conventional approaches also include issuing coupons or rewards for customer referrals, for participation on social media promotions, or for other actions by a consumer that implicitly or explicitly endorse the given business.

Regarding relevance of promotional offers, including suggesting offers to specific consumers based on stated or inferred areas of interest, conventional approaches include recommendation engines that use a consumer's historical purchase behavior to recommend other products or services of interest. Conventional approaches also include making recommendations based on a consumer's explicitly stated areas of interest, such as checking a box to indicate interest in receiving advertisements related to a designated topic. Conventional approaches additionally include targeting consumers with location-based offers by using their geographic location as determined by a geographically constrained search, or by passively monitoring the position of a consumer's mobile computing device.

There are many drawbacks with these conventional approaches. Conventional approaches that distribute promotional offers to large population of recipients forfeit exclusivity. Promotional systems that are unaware of other business promotions are unable to deliver an acceptable consumer experience. E.g., if, instead of search engine advertisements being centrally brokered by Google and shown on the sidebar of a webpage, every business would independently cause a pop-up to display on consumers' screens in response to searches, consumers would reject such uncoordinated advertising as being intrusive and as subjecting them to a barrage of advertisements. Promotional systems that do not automatically measure consumer response cannot adapt scheduling or distribution based on real-time receipt of results and, therefore, are unable to adhere to business goals and settings.

Thus it will be appreciated that there would be great benefit in providing automated promotional offer management and distribution systems and methods that overcome these drawbacks and enjoy the benefits (i)-(ix) above.

### SUMMARY OF THE DESCRIPTION

Today's information technology makes it possible for the present invention to provide automated promotional offer management and distribution systems and methods that overcome drawbacks of conventional systems and methods, and enjoy the various benefits described above. Embodiments of the present invention provide scalable, automated ways for businesses to send welcomed, permission-based advertisements to targeted sets of consumers via push/interrupt channels that prompt them at unexpected times and elicit decisions quickly and interactively, while simultaneously increasing the sense of urgency, excitement, relevance and exclusivity experienced by consumers.

Embodiments of the present invention provide advantages to both consumers and businesses. Consumers benefit from respect of their contact settings for individual businesses and for all business in aggregate. Additionally, consumers enjoy a high degree of relevance associated with promotional offers that they receive. Because consumers feel assured that they will only receive high quality, relevant offers at times and in quantities that respect their contact settings, consumers give businesses permission to send them proactive push-notification promotions. Due to the business' control afforded by the present invention, and the access they receive by consumers to distribute permitted push-notification marketing, consumers additionally reap the benefit of receiving offers that a business would not normally be willing to distribute in an uncontrolled fashion or via conventional mass-marketing channels.

Using the present invention, businesses benefit from automated scheduling, which saves time and management overhead, and enables businesses to send more frequent promotions to smaller distribution lists. Automated scheduling in the present invention is tied to business goals, resulting in a steady consistent trickle of promotional offers, in distinction from conventional approaches that suffer from variability and potential surges in responses due to mass marketing. Automated scheduling of the present invention enables campaign selection and refinement through response analysis.

Using the present invention, businesses also benefit from two-way push-notification promotions, for which a consumer receives an offer that proactively gains his attention and requires that he respond in order to activate the offer and receive the benefit of the promotion. In accordance with embodiments of the present invention, distribution of two-way promotional offers adapts itself based on consumer responses and, as such, businesses don't distribute wasteful messages, which enables them to distribute more offers to consumers overall. E.g., if a business didn't distribute a promotion to a consumer unnecessarily on Monday, the consumer will still be interested in hearing from the business on Wednesday. Two-way promotions are automatically tracked and results are analyzed, and this information is used to refine promotion scheduling, and provides one metric to measure consumer engagement. In accordance with embodiments of the present invention, two-way promotions initiated by push notification also allow for urgency in communications.

Using the present invention, businesses also benefit from private communication channels. Businesses are able to target specific consumers to receive promotional offers. In accordance with an embodiment of the present invention, not every consumer is eligible to receive every deal. In distinction, with conventional approaches where offers are made through mass marketing channels such as public websites or applications, every consumer can see every deal which (i) diminishes a business' ability to communicate exclusivity, (ii) diminishes the business' ability to offer a promotion to only select consumers, and (iii) eliminates the business' ability to run promotions continuously without appearing desperate.

Using the present invention, businesses are able to provide consumers unique experiences that businesses would not be able to provide through conventional approaches.

There is thus provided in accordance with an embodiment of the present invention a method for managing distribution of business promotional offers by a server computer, including receiving, by a server computer, from each of a plurality of business, one or more definitions for promotional offers, each definition comprising at least one distribution constraint, and one or more scheduling constraints, receiving, by the server computer, from each of a plurality of consumers, a plurality of preferences for receiving promotional offers, and deriving, by the server computer, a schedule for distributing specific promotional offers to specific consumers at specific dates and times, in accordance with the distribution constraints, the scheduling constraints and the consumer preferences.

There is additionally provided in accordance with an embodiment of the present invention a system for managed distribution of business promotional offers, including a business-side interface for enabling each of a plurality of businesses to submit one or more definitions of promotional offers, each definition comprising at least one distribution constraint, and one or more scheduling constraints, a consumer-side interface for enabling each of a plurality of consumers to submit preferences for receiving promotional offers, a scheduler for deriving a schedule for distributing specific promotional offers to specific consumers at specific dates and times, in accordance with the distribution constraints, the scheduling constraints and the consumer preferences, and an event handler for invoking the scheduler in response to submissions by business and by consumers processed respectively by the business-side interface and the consumer-side interface, and in response to messages received by the system.

As used herein, the term “promotional offer” refers to an offer by a business to a consumer for goods or services, including inter alia (i) a discount towards a purchase of goods or services, (ii) a gift of goods or services, and (iii) special privileges, e.g., meeting a chef, getting a reservation, or being guaranteed preferred seating. In addition, the term “promotional offer” may refer to a template form of a promotional offer from which additional offers of the same or similar structure and content may be scheduled and distributed by the system. As used herein, the term “promotion” refers to the distribution of one or more of the same or similar promotional offers from the same business, to one or more consumers.

### BRIEF DESCRIPTION OF THE DRAWINGS

The present invention will be more fully understood and appreciated from the following detailed description, taken in conjunction with the drawings in which:

FIG. 1 is a simplified block diagram of a system for managed distribution of business promotional offers, in accordance with an embodiment of the present invention;

FIG. 2 is a simplified flowchart of one event path of a method for managing distribution of business promotional offers, in accordance with an embodiment of the present invention;

FIG. 3 is an exemplary screen shot for enabling a business to create an account within the system of FIG. 1, in accordance with an embodiment of the present invention;

FIG. 4 is an exemplary screen shot of a user interface for enabling a business to create an administrator within the system of FIG. 1, in accordance with an embodiment of the present invention;

FIG. 5 is an exemplary screen shot of a user interface for enabling a business to set scheduling constraints within the system of FIG. 1, in accordance with an embodiment of the present invention;

FIG. 6 is an exemplary screen shot of a user interface for enabling a business to create a promotional offer within the system of FIG. 1, in accordance with an embodiment of the present invention;

FIG. 7 is an exemplary screen shot of a user interface for enabling a business to add a promotional distribution constraint within the system of FIG. 1, in accordance with an embodiment of the present invention;

FIG. 8 is an exemplary screen shot of a user interface for enabling a consumer to create an account within the system of FIG. 1, in accordance with an embodiment of the present invention;

FIG. 9 is an exemplary screen shot of a user interface for enabling a consumer to add a promotional receipt preference within the system of FIG. 1, in accordance with an embodiment of the present invention;

FIG. 10 is a simplified flowchart of a method for a promotion that is in a SCHEDULED state, in accordance with an embodiment of the present invention;

FIG. 11 is a simplified flowchart of a method for a promotion that is in a PENDING state, in accordance with an embodiment of the present invention;

FIG. 12 is a simplified flowchart of a method for a promotion that is in a RUNNING state, in accordance with an embodiment of the present invention;

FIG. 13 is a simplified flowchart of a method for a promotion that is in an ALL OFFERS SENT state, in accordance with an embodiment of the present invention;

FIG. 14 is a simplified flowchart of a method for identifying available consumers to receive a promotional offer, in accordance with an embodiment of the present invention; and

FIG. 15 is a simplified flowchart of a method for processing an incoming message from a consumer, in accordance with an embodiment of the present invention.

### LIST OF APPENDICES

APPENDIX A is a listing of pseudo-code for scheduling promotions, in accordance with an embodiment of the present invention;

APPENDIX B is a listing of pseudo-code for ranking and selecting available consumers, in accordance with an embodiment of the present invention; and

APPENDIX C is a listing of internally generated events and externally generated events, in response to which a scheduler may be invoked to dynamically schedule or distribute promotional offers, in accordance with an embodiment of the present invention.

### DETAILED DESCRIPTION

Aspects of the present invention relate generally to managed distribution of promotional offers from businesses to consumers through immediate and private two-way channels of communication. By distributing promotional offers through such channels, promotional offers are able to require that a recipient reply in order to activate, or claim the offer. As such, the promotional distribution system of the present invention obtains real-time feedback on how many consumers have claimed a given offer, and may respond accordingly by dynamically updating message distribution routines, or by replying to a consumer with an additional message, including inter alia a redemption instruction, an alternate promotional offer, and an informational message.

In one embodiment, promotional offers are distributed to consumer subscribers via their mobile phones. When a consumer receives a message that includes a promotional offer from a business, he may choose to activate the offer by performing an action using his phone, including inter alia (i) replying with an activation code via SMS, e-mail or such other protocol, or (ii) visiting a website and clicking a button. Upon activation, the consumer is sent a redemption code, which he presents to the business to redeem the offer.

As described below, the present invention allows for a wide variety of types of promotional offers. Some exemplary promotions are as follows, in which certain portions of the promotional wording are shown in a “#{name}” format, indicating that those section are replaced dynamically.
“Get $#{reward} off $#{value}, good through #{expiry}.”
“Extended happy hour for you and 3 friends, good from 4 PM to 9 PM. Use by #{expiry}. This offer will be sent to a maximum of #{max offers} people, the first #{max activations} to reply “#{activation code}” get it. You are the #{distribution order} person to receive this offer, #{remaining activations} activations remain at this time.”
“Get #{$ reward} off when you spend #{$ value} or more. Will tap #{max offers} people, the first #{max activations} to reply “#{activation code}” gets it. Use by #{expiry}.”
“Half price 1 hr. private yoga class when you bring a friend. Call to schedule a time before #{expiry}. This offer will be sent to a maximum of #{max offers} people, the first #{max activations} to reply “#{activation code}” get it.”
“4 PM opening for hair coloring treatment today, #(date}. This offer will be set to #{max offers} people one at a time, the first one to reply “#{activation code}” gets it. You are the #{distribution order} person to receive this offer.”
“#{$reward} off #{$ value} or more with proof of full-price receipt for a least $25 in the past 2 weeks. Use by #{expiry}. This offer will be sent to #{max offers} people, all to reply “#{activation code}” get it.”

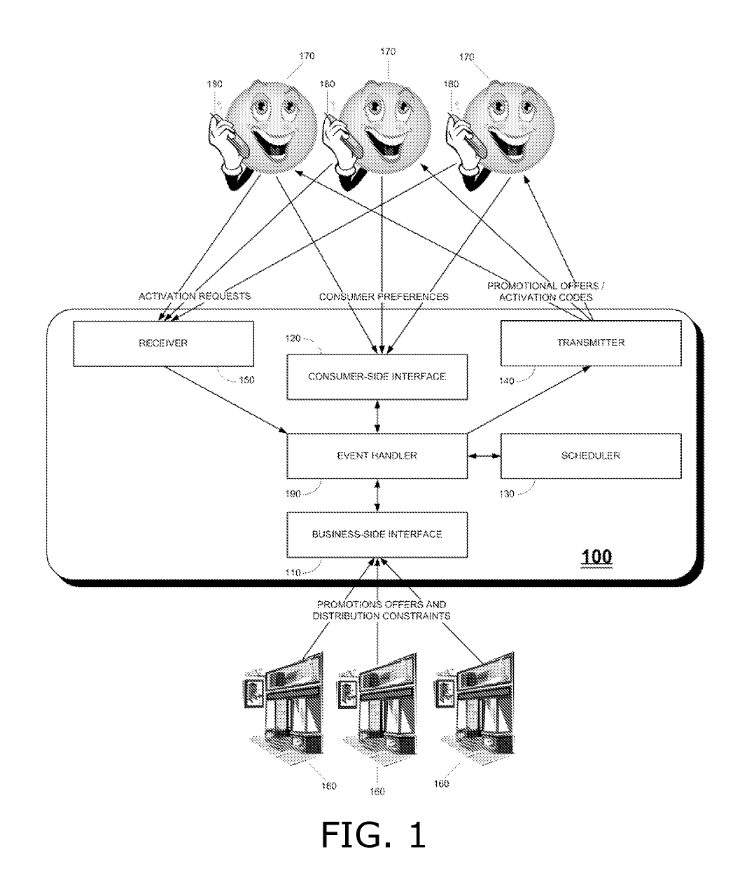

Reference is made to FIG. 1, which is a simplified block diagram of a system 100 for managed distribution of business promotional offers, in accordance with an embodiment of the present invention. System 100 includes six primary components; namely, a business-side interface 110, a consumer-side interface 120, a scheduler 130, a transmitter 140, a receiver 150 and an event handler 190. As described in detail below, business-side interface 110 enables a plurality of businesses 160, which subscribe to system 100, to submit (i) definitions of promotional offers that they permit system 100 to use as templates, to periodically schedule and distribute similar promotional offers on their behalf to consumers, each definition including one or more distribution constraints, and (ii) one or more scheduling constraints which govern the scheduling and distribution of promotional offers submitted by a particular business 160.

The present invention allows for a wide variety of distribution constraints that pertain to individual promotional offers, including inter alia:
limits on the frequency with which a promotional offer is transmitted to all consumers;
limits on the frequency with which a promotional offer is transmitted to one or more specific consumers;
limits on the number of consumers to whom a promotional offer is transmitted;
designations of who may receive a promotional offer, e.g., one or more named consumers, one or more categories of consumers as categorized by their promotional receipt preferences, or one or more categories of consumers as categorized based on analysis of consumers' event histories such as engagement points earned;
designated weekdays, dates or other calendar times on which a promotional offer may be distributed;
designated periods during a given day when a promotional offer may be distributed;
limits on the number of redemption codes that system 100 may grant for a specific promotional offer;
limits on the time period for a consumer to activate a promotional offer, specified by a designated date and time; and
limits on the time period for a consumer to activate a promotional offer, measured from the time the promotional offer was transmitted to him.

In addition to direct distribution constraints, a business submitting a promotional offer can define related financial goals for the promotional offer that are used by system 100 when determining a schedule of promotional offers. The present invention allows for a wide variety of financial goals, including inter alia:
an associated promotional dollar amount for a promotion, e.g., $50, which provides a measure of the size of a promotional offer for the purpose of scheduling;
an associated discount dollar amount for the promotion, e.g., $20, which provides a measure of the cost of the promotional offer to the business for the purpose of scheduling;
total goals for a given time period for a promotion, such as the total number of redemption codes that may be granted per calendar week; and
total goals over the lifetime of a promotion, such as the total number of redemption codes that may be ever be granted.

In addition to distribution constraints that pertain to individual promotional offers, a business may submit one or more scheduling constraints that govern the scheduling, distribution and redemption codes issued for promotion offers, including inter alia:
days on which promotional offers may be scheduled;
days on which promotional offers cannot be scheduled, such as specific closures, holidays or recurring days when the business is closed;
a maximum aggregate number of consumers for a particular day of the week or time period, which governs how may discrete promotional offer messages may be distributed on that day;
a maximum aggregate promotional dollar amount for a particular day of the week or time period, which governs how many redemption codes may be issued by all promotional offers distributed on that day; and
a maximum aggregate discount dollar amount for a particular day of the week or time period, which governs how many redemption codes may be issued by all promotional offers distributed on that day.

As described in detail below, consumer-side interface 120 enables a plurality of consumers 170, who subscribe to system 100, to submit their preferences for receiving promotional offers. In accordance with one embodiment of the present invention, each consumer 170 has a mobile phone 180 to which transmitter 140 transmits promotional offers.

The present invention allows for a wide variety of consumer preferences, including inter alia:
a venue of businesses with promotional offers;
a name of a business with multiple venues;
a set of venues with promotional offers as defined by inclusion in a specific geographic area;
a set of venues with promotional offers as defined by inclusion in a business category;
a set of venues with promotional offers as defined by inclusion in a group of businesses recommended by system 100 to the consumer, based on analysis of aggregate consumer preferences and behavior;
time periods during which the consumer may receive promotional offers from one or more businesses or venues of businesses, including inter alia days of the week, specific dates, or hours within specific days;
a maximum frequency of receipt of promotional offers from a designated business, within a given time period;
a maximum frequency of receipt of promotional offers in aggregate from all businesses, within a given time period; and
a restriction on receiving promotional offers for one or more businesses until a specific date or during a specific time period.

As described in detail below, scheduler 130 derives a distribution schedule for distributing specific promotional offers to specific consumers 170 at specific dates and times, in accordance with the distribution constraints, the scheduling constraints and the consumer preferences.

Transmitter 140 distributes the specific promotional offers to the specific consumers 170 at the specific dates and times derived by scheduler 130. Transmitter 140 may distribute the promotional offers via any mode of push notification or polling used to alert the consumers, known today or to be developed in the future, including inter alia SMS messages, e-mail messages, and automated telephone calls.

Upon receipt of a promotional offer from a business 160, a consumer 170 may be required to attempt to activate the offer by sending an activation communication to receiver 150, which causes event handler 190 to determine whether to send a redemption code via transmitter 140 for presentation to business 160 to redeem the offer. Issuance of redemption codes is of advantage as it enables system 100 to dynamically adjust promotion distribution and scheduling of subsequent promotions, thereby adhering precisely to the scheduling and distribution constraints of business 160. Additionally, issuance of redemption codes is of advantage as it provides business 160 with a unique code that identifies a specific consumer 170 who received a specific promotional offer and was granted a redemption code, which enables convenient mechanisms to prevent fraud, and to track total consumer spending associated with a promotion. The redemption code may be selected from a predetermined list of codes. Use of predetermined codes is of advantage in providing a pre-determined schedule to businesses; e.g., weekly upcoming promotional offers and redemption codes schedules that are tied to a calendar, which enable convenient tracking of promotional redemptions, consumer spending, and prevention of fraudulent use or multiple uses of a redemption code.

Consumer 170 may attempt to activate his promotional offer via a number of modes of communication, including inter alia via an SMS message, via an e-mail message, via his telephone using the keypad, via a mobile phone application, and by browsing a web page and clicking a control on the page.

For distribution constraints that limit the number of redemption codes that may be transmitted, the promotional offer may indicate that redemption codes will be transmitted only to the first respondents. For example, a promotional offer may have a description including “Only the first two respondents to reply to this promotional offer will receive redemption codes”.

As described below, event handler 190 orchestrates the workflow of system 100. Event handler 190 invokes the necessary modules to processes incoming messages, to determine one or more actions to perform in response to incoming messages, to generate reply messages as appropriate, and to store event data analyzed by system 100 in accordance with certain promotional offer scheduling and distribution routines.

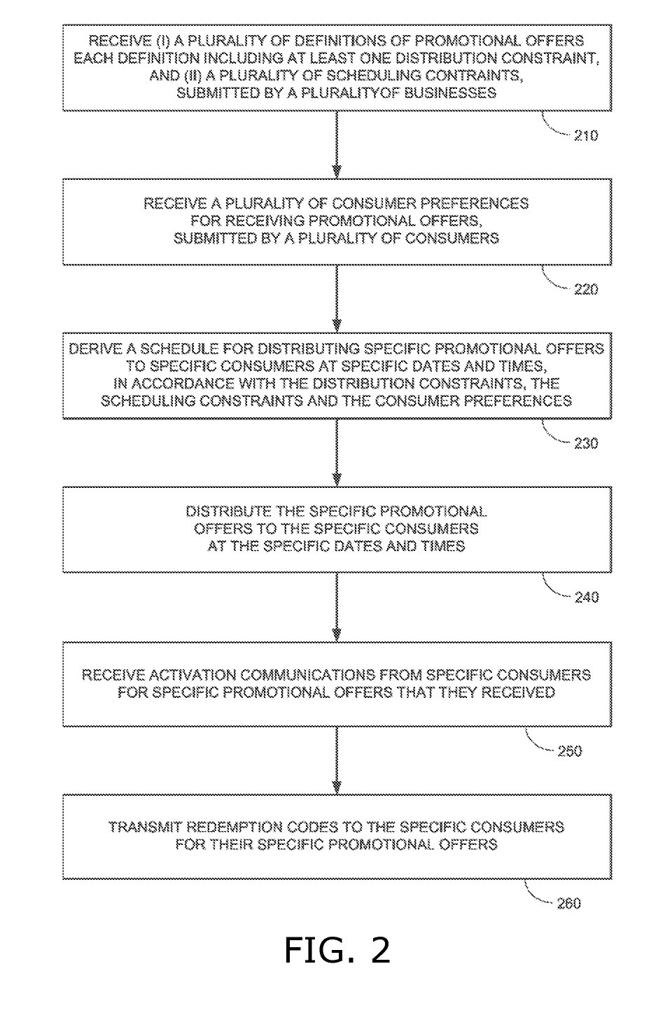

Reference is made to FIG. 2, which is a simplified flowchart of one event path of a method for managing distribution of business promotional offers, in accordance with an embodiment of the present invention. At operation 210, a computer receives (i) a plurality of definitions of promotional offers, each definition including at least one distribution constraint, and (ii) a plurality of scheduling constraints, submitted by a plurality of businesses. At operation 220, the computer receives a plurality of consumer preferences for receiving promotional offers, from a plurality of consumers, as described in detail below. At operation 230, the computer derives a schedule for distributing specific promotional offers to specific consumers at specific dates and times, in accordance with the distribution constraints, the scheduling constraints and the consumer preferences, as described in detail below. At operation 240, the computer distributes the specific promotional offers to the specific consumers at the specific dates and times. The promotional offers may be distributed at operation 240 as SMS messages, as e-mail messages, as automated telephone calls, or via any other such mode of wired or wireless communication known today or to be developed in the future.

At operation 250, the computer receives activation messages from specific consumers for the specific promotional offers that were distributed to them at operation 240. At operation 260, the computer transmits redemption codes to the specific consumers for redeeming their specific promotional offers. The computer may optionally transmit a message to business administrators at this time, alerting them that a consumer activated a promotional offer, and providing relevant details of the offer including inter alia the promotional message, details identifying the consumer, and the redemption code issued to the consumer.

At any time, event handler 190 may invoke operation 230 to dynamically schedule promotions or to adjust running promotion parameters such as distribution settings, in response to an event such as receipt of an activation communication at operation 250, or definition by a consumer of an additional consumer preference at operation 220. The ability of system 100 to invoke operation 230 in response to events, resulting in optional distribution of promotions, or modifications to promotional distribution in accordance with consumer and business preferences, enables numerous extensions by system 100 to distribute promotional offers in response to a dynamic marketing landscape. Additional internally generated events and externally monitored events, in accordance with an embodiment of the present invention, are listed in APPENDIX C. It will be appreciated by those skilled in the art that there is a large number of possible event handling paths and subsequent actions by system 100, not all of which conform to a linear progression of events, and that FIG. 2 illustrates one simple instance of a possible event path for distribution of promotional messages.

### Business-Side Interface 110

Business-side interface 110 assists a business in defining promotional offers and constraints, including inter alia promotional language and parameters. Business interface 110 also provides templates for promotional offers, which can be used and modified.

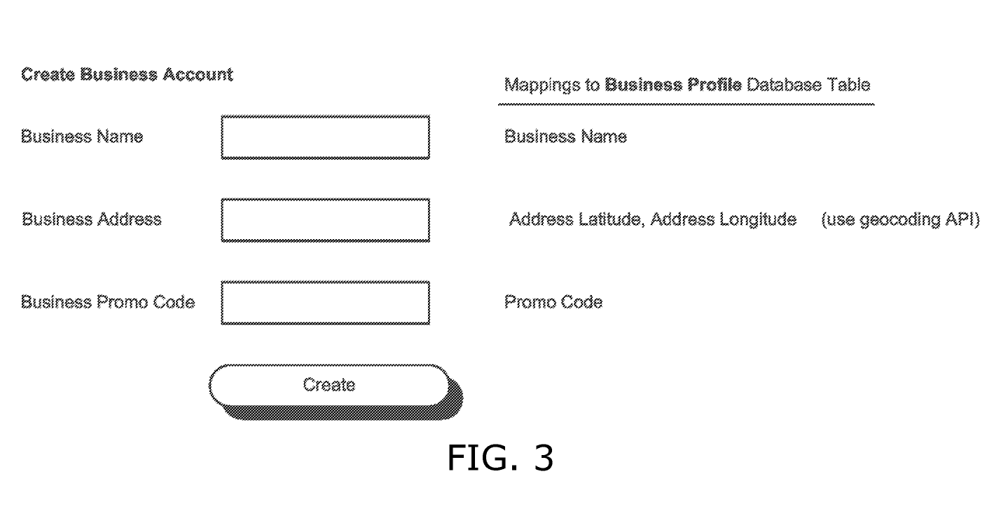

Reference is made to FIG. 3, which is an exemplary screen shot provided by business-side interface 110 for enabling a business 160 to create an account within system 100, in accordance with an embodiment of the present invention. As shown in FIG. 3, business-side interface 110 provides entries for business 160 to provide a business name, a business address, and a business promo code. Descriptions of these entries appear in TABLE I below. FIG. 3 also shows how these entries map to fields in TABLE I.

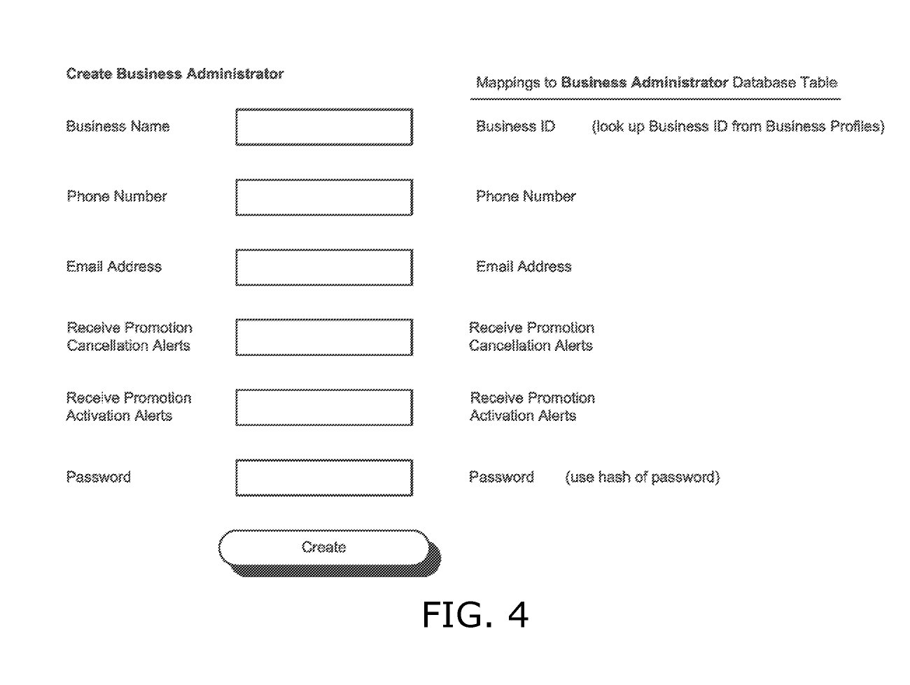

Reference is made to FIG. 4, which is an exemplary screen shot of a user interface provided by business-side interface 110 for enabling a business 160 to create an administrator within system 100, in accordance with an embodiment of the present invention. As shown in FIG. 4, business-side interface 110 provides entries for a business name, a phone number, an email address, an option to receive promotion cancellation alerts, an option to receive promotion activation alerts, and a password. Descriptions of these entries appear in TABLE II below. FIG. 4 also shows how these entries map to fields in TABLE II.

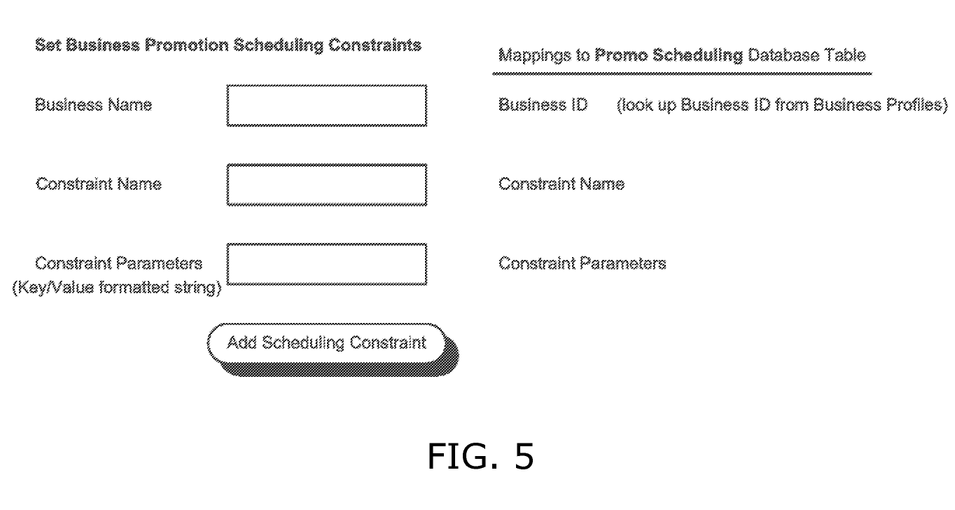

Reference is made to FIG. 5, which is an exemplary screen shot provided by business-side interface 110 for enabling a business 160 to set scheduling constraints within system 100, in accordance with an embodiment of the present invention. As shown in FIG. 5, business-side interface 110 provides entries for a business name, a constraint name, and constraint parameters. Constraint parameters are formatted as key/value pairs. Descriptions of these entries appear in TABLE III below. FIG. 5 also shows how the entries map to fields in TABLE III.

Use of constraint names and constraint parameters allow for virtually any desired business-wide scheduling parameter, with a generic description/database schema, and logic implemented in scheduler 130. Some examples of constraint names and types include

Constraint Name

| | |
|---|---|
| Monday Maximum | {“dollar_value”:”100”} |
| Dollar Value | |
| Wednesday | {“hour”:”10”} |
| Business Opening | |
| Hour | |
| Closed on Date | {“date”:”12/25/2011”} |
| Blocked Consumer | {“consumer_id”:”443”,“until_date”;”12/25/2011”) |

Scheduler 130 references constraint names and their parameters to perform logic defined in scheduler 130 for the named constraint, to test whether the given constraint passes or fails, given the state of system 100 at the time the test is performed. E.g., schedule 130 looks up all “Closed on Date” scheduling constraints for a business, to check if any of their dates match the current date.

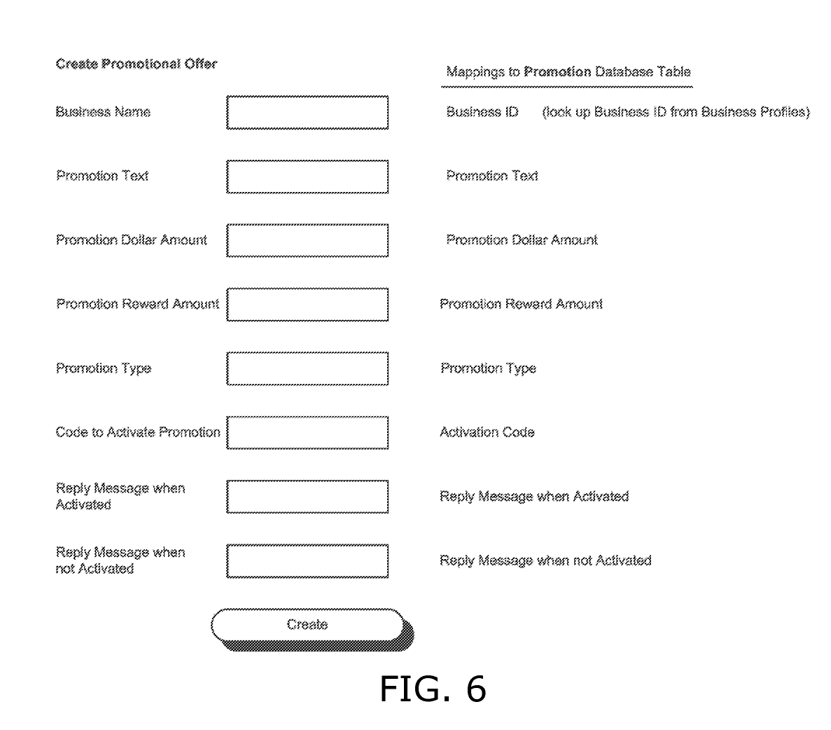

Reference is made to FIG. 6, which is an exemplary screen shot provided by business-side interface 110 for enabling a business 160 to create a promotional offer within system 100, in accordance with an embodiment of the present invention. As shown in FIG. 6, business-side interface 110 provides entries for business name, promotion text, promotion dollar amount, promotion reward amount, promotion type, code to activate promotion, an option for reply message when activated, and an option for reply message when not activated. Descriptions of these entries appear in TABLE IV below. FIG. 6 also shows how the entries map to fields in TABLE IV below.

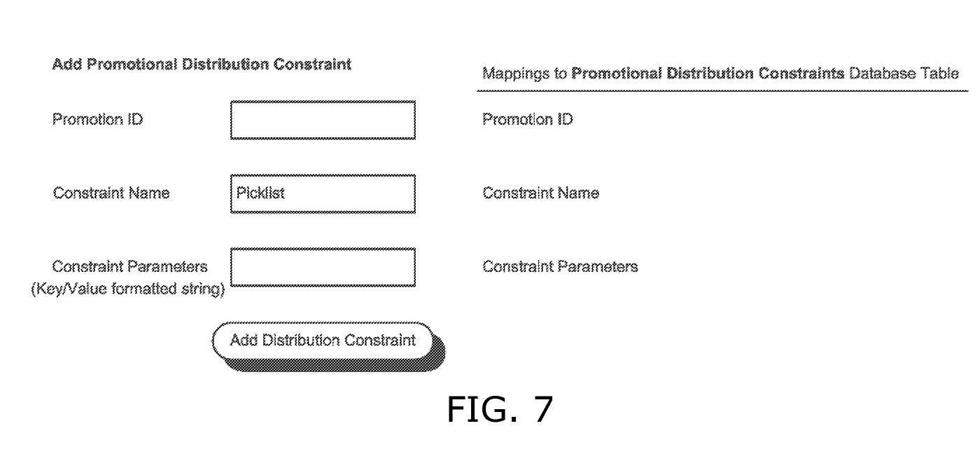

Reference is made to FIG. 7, which is an exemplary screen shot provided by business-side interface 110 for enabling a business 160 to add a promotional distribution constraint within system 100, in accordance with an embodiment of the present invention. As shown in FIG. 7, business-side interface 100 provides entries for promotion ID, constraint name, and constraint parameters. Constraint parameters are formatted as key/value pairs. Descriptions of these entries appear in TABLE V below. FIG. 7 also shows how the entries map to fields in TABLE V below.

Some examples of constraint names and types include

Constraint Name

| | |
|---|---|
| Monday Can Run? | {“value”:”true”} |
| Tuesday Can Run? | {“value”:”false”} |
| Send only to users | {“user_ids”:”{2,5,44}”} |
| Can use as template? | {“value”:”true”} |
| Cost to activate in activation | {“activation_credit_cost”:”50”} |
| credits | |
| Engagement Pts needed to | {“engagement_pt_threshold”:”250”} |
| Receive | |

### Consumer-Side Interface 120

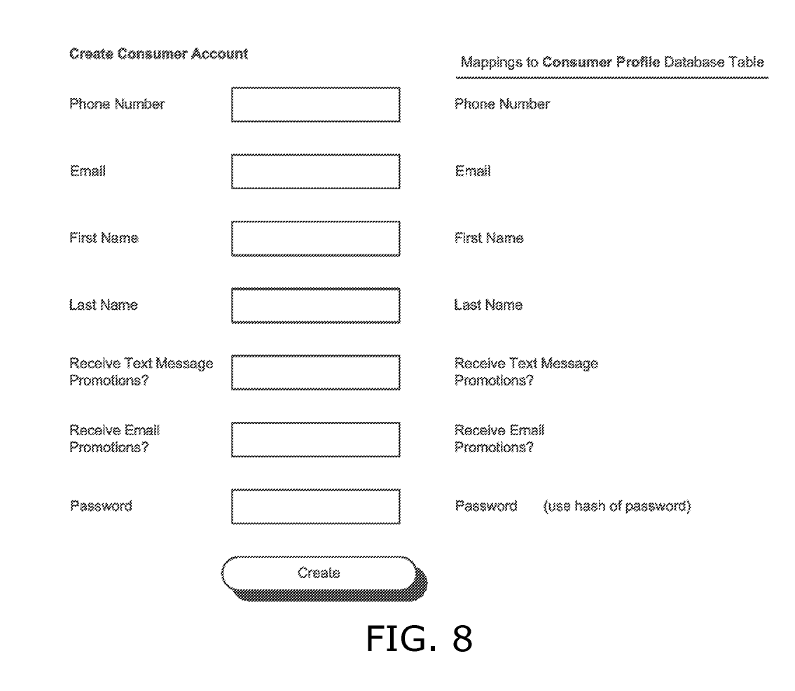

Reference is made to FIG. 8, which is an exemplary screen shot provided by consumer-side interface 120 for enabling a consumer 170 to create an account within system 100, in accordance with an embodiment of the present invention. As shown in FIG. 8, consumer-side interface 120 provides entries for phone number, email, first name, last name, an option to receive text message promotions, an option to receive email promotions, and a password. Descriptions of these entries appear in TABLE VI below. FIG. 8 also shows how the entries map to fields in TABLE VI below.

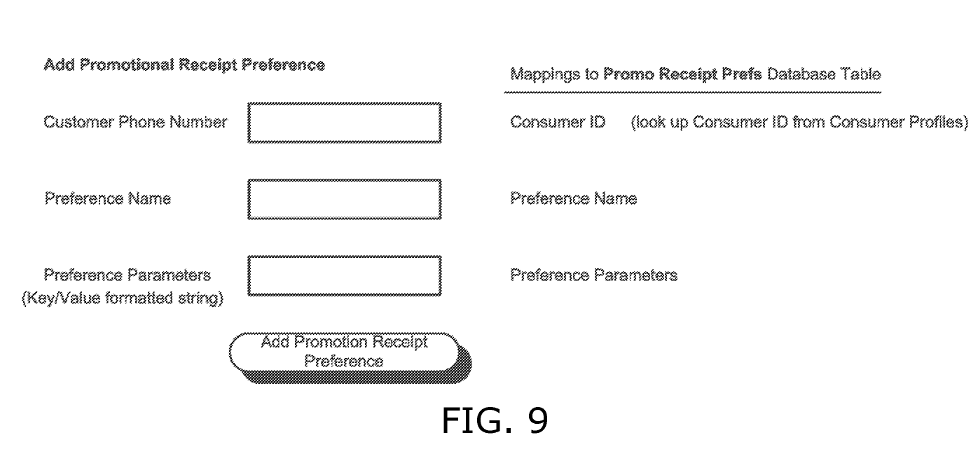

Reference is made to FIG. 9, which is an exemplary screen shot provided by consumer-side interface 120 for enabling a consumer 170 to add a promotional receipt preference within system 100, in accordance with an embodiment of the present invention. As shown in FIG. 9, consumer-side interface 120 provides entries for customer phone number, preference name, and preference parameters. Preference parameters are formatted as key/value pairs. Descriptions of these entries appear in TABLE VII below. FIG. 9 also shows how the entries map to fields in TABLE VII below.

Some examples of constraint names and types include

Constraint Name

| | |
|---|---|
| Business Allowed | {“business_id”:”245”} |
| Tuesday Hours Available | {“start_hour”:”9”,“end_hour”:”20”}} |
| Allow all businesses | {“value”:”false”} |
| Max daily promotions in | {“value”:”true”) |
| aggregate | |
| Min days between same bus | {“value”:”7”) |
| promotion | |
| Block business | (“business_id”:”245”, |
| | “until_datetime”:”12/01/2011 04:15 PM} |
| All businesses in geography | {“address”:”3151 NE Sandy Blvd, |
| allowed | Portland OR 97232”, |
| | ”within_miles”:”5”} |

### Scheduler 130

Scheduler 130 determines which promotions to run; what the maximum activations for each promotion should be, namely, “Activations allowed” in TABLE IV below; how many consumers to distribute promotional offers to, namely, “Maximum consumer distribution list” in TABLE IV; and on which dates and times to run each promotion, namely, “Scheduled for” in TABLE IV. For each business 160 that is a subscriber to system 100, scheduler 130 determines which of its promotions can be scheduled, and what their constraints are, and schedules promotions to be run, periodically or as instructed by event handler 190. For each consumer 170 that is a subscriber to system 100, scheduler 130 determines which consumers are available for which businesses on which days. For each promotion, scheduler 130 determines, based on an event history for equivalent promotions, certain settings that govern message distribution including inter alia the average number of discrete promotional offer messages distributed to elicit an activation attempt, and the average time between sending a discrete promotional offer message to a consumer and receiving an activation attempt by the consumer.

Scheduler 130 generates promotion instances, which are woken up and processed at scheduled dates and times. A promotion instance includes inter alia:
a promotion identifier;
a date and time to run the promotion;
a maximum number of recipients; and
a maximum number of redemption codes to issue.

Certain events cause scheduler 130 to regenerate one or more schedules and to recalculate parameters for scheduled or running promotion instances.

In accordance with an embodiment of the present invention, a schedule may also be determined manually by scheduling, such as by an administrator of a business, a promotional offer for a specified time. The manual scheduling may be performed via a website or such other application interface; or via a message, such as an SMS message, that conforms to a specified command format.

In accordance with an embodiment of the present invention, a schedule may also be generated in response to an event handled by event handler 190, including inter alia:
a consumer opting in, or designating a consumer preference to receive promotional offers from a specific business;
a consumer sending a message, such as “Mobilize me and 5 friends”;
a consumer sending feedback to a specific business;
a consumer performing an action such as “liking” a business on FACEBOOK®, or following a business TWITTER®; and
a business administrator sending a command message, such as “Run promotion {promo ID}”.
   APPENDIX C includes additional events that may cause event handler 190 to invoke scheduler 130.

### Event Handler 190

Event handler 190 invokes the necessary modules to process events that occur, such as receipt of incoming messages by receiver 150, and determines one or more action to perform in response thereto. Event handler 190 invokes the necessary modules to perform the one or more actions. Event handler 190 also invokes the necessary modules to generate one or more reply messages for transmission by transmitter 140, based on the one or more actions performed. The one or more actions performed in response to events that occur generally impact other modules of system 100.

TABLE VIII below shows entries for a system message, in accordance with an embodiment of the present invention.

Events that are processed by event handler 190 include inter alia:
receipt of an incoming command or other message from a consumer or from a business administrator;
creation of a new consumer preference; and
updating of a distribution or scheduling constraint.

Actions to be performed in response to events include inter alia:
query for recent promotional offers sent to a consumer, to determine if an incoming message corresponds to an activation code and thus is an activation attempt;
check if an activation is available;
check if any opt-in promotional offers are defined by a business, to determine whether a promotion should be scheduled instantly in response to a change in a consumer promotional receipt preference;
check if a command to opt-in to a business relates to a named business;
create a consumer preference in response to an incoming opt-in message or an incoming promotion activation message from a consumer;
cancel a pending promotion in response to an incoming cancellation message from a business administrator;
schedule a promotion in response to an incoming message from a consumer, such as “mobilize me and 5 friends”; and
schedule a promotion in response to an incoming message from a business administrator, such as “run a designated promotion”.

In accordance with an embodiment of the present invention, system 100 maintains an event history, and event handler 190 logs messages sent and received and the actions performed in response thereto and the related parties in the event history. System 100 uses the event history inter alia to calculate, for a given promotion, (i) an average number of promotional offers required for similar promotions in order to solicit an activation, and (ii) an average response time for similar promotions; and, for consumer activity as it pertains to promotion distribution constraints, (iii) the total engagement points earned by a consumer over a given time period for one or more types of events. The average number is used to determine a maximum consumer distribution list for a promotional offer, in order to elicit a target number of activations. The average response time is used to determine how long a running promotion should wait for possible activation responses between cycles of distributing additional promotional messages. The total engagement points earned is used by certain promotional distribution constraints to determine which consumers are eligible to receive the given promotional offer.

### Operation 210

In accordance with an embodiment of the present invention, the promotional offers submitted by subscribing businesses 160 are represented by relational database tables. A profile for each business, as submitted for example via the screens shown in FIGS. 3 and 4, is stored as shown in TABLES I and II below.

Definitions of promotional offers specify the messaging, interaction and other information that together defines a promotional offer. A promotional offer, as submitted for example via the screen shown in FIG. 6, is stored as shown in TABLE IV below.

Scheduling constraints may be generated by businesses via business-side interface 110. Alternatively, scheduling constraints may be generated in response to messaging actions via SMS or e-mail, or such other mode of communication. A scheduling constraint, as submitted for example via the screen shown in FIG. 5, is stored as shown in TABLE III below.

Distribution constraints may be generated by businesses via business-side interface 110. Alternatively, distribution constraints may be generated in response to messaging actions via SMS or e-mail, or such other mode of communication. A distribution constraint, as submitted for example via the screen shown in FIG. 7, is stored as shown in TABLE V below.

### Operation 220

In accordance with an embodiment of the present invention, the consumer preferences submitted by subscribing consumers 170 are represented by relational database tables. A profile for each consumer, as submitted for example via the screen shown in FIG. 8, is stored as shown in TABLE VI below.

Consumer preferences may be defined by consumers via consumer-side interface 120. Alternatively, consumer preferences may be defined in response to messaging actions via SMS or e-mail, or such other mode of communication. For example, a consumer may opt in to a business, thereby setting an “allowed business” preference, by clicking on the business on a map and then clicking on an “opt in” control. Alternatively, a consumer may opt in to a business by sending an SMS message or an e-mail message to system 100 with a code for the business. Types of consumer preferences include inter alia names of businesses, venues of businesses, preferred geographic areas, global days and maximum frequency preferences, and business-specific days and maximum frequency preferences. Consumer preferences, as submitted for example via the screen shown in FIG. 9, are stored as shown in TABLE VII below.

In accordance with an embodiment of the present invention, additional consumer preferences, such as a preference blocking a specific business from sending additional promotional messages in a specified time period, are generated based on consumer preferences, in response to certain events. For example, a business-specific preference as to how frequently that business can send promotional offers to a given consumer, causes system 100 to add a business block consumer preference for that consumer at the time the consumer receives a promotion from that business.

Consumer preferences may override one another. For example, a business-specific days and frequency consumer preference overrides a general days and frequency consumer preference. Other types of consumer preferences not shown in the tables below include inter alia recommended thresholds for specific businesses, business categories, premium deals permitted, and total activation restriction.

### Operation 230

Reference is made to APPENDIX A, which is a listing of pseudo-code for scheduling promotions, in accordance with an embodiment of the present invention.

### Operation 240

When a promotion has been scheduled, a record is entered in a database indicating when to initially process, or run the promotion. A monitor checks the database, loads the promotion and processes it. When the promotion is processed, a set of actions are performed in accordance with the state of the promotion and type of the promotion. A typical promotion, in accordance with an embodiment of the present invention, evolves through a progression of states:

### SCHEDULED→PENDING→RUNNING→ALL OFFERS SENT→COMPLETED

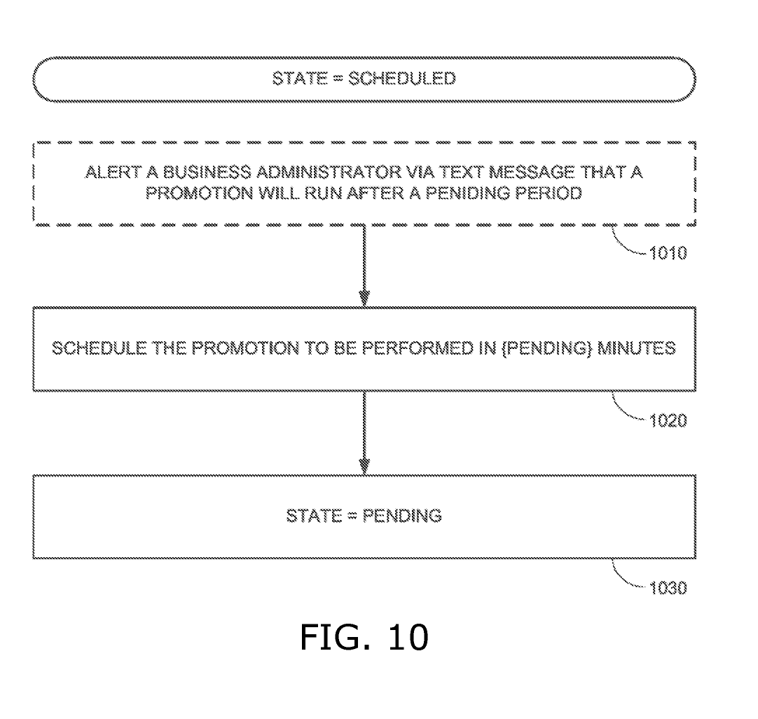

Reference is made to FIG. 10, which is a simplified flowchart of a method for a promotion that is in a SCHEDULED state, in accordance with an embodiment of the present invention. At operation 1010 an alert is optionally sent to a business administrator via text message, e-mail or automated phone call, or such other means of communication, indicating that the promotion will run after a pending period. The message instructs the administrator to reply ABORT via a designated communication protocol to cancel the promotion directly, or to cancel the promotion online. Operation 1010 is optional, based on selection of the Receive Promotion Cancellation Alerts entry in FIG. 4.

At operation 1020 the promotion is scheduled to be performed in a designated number of minutes, and at operation 1030 the state of the promotion evolves to PENDING.

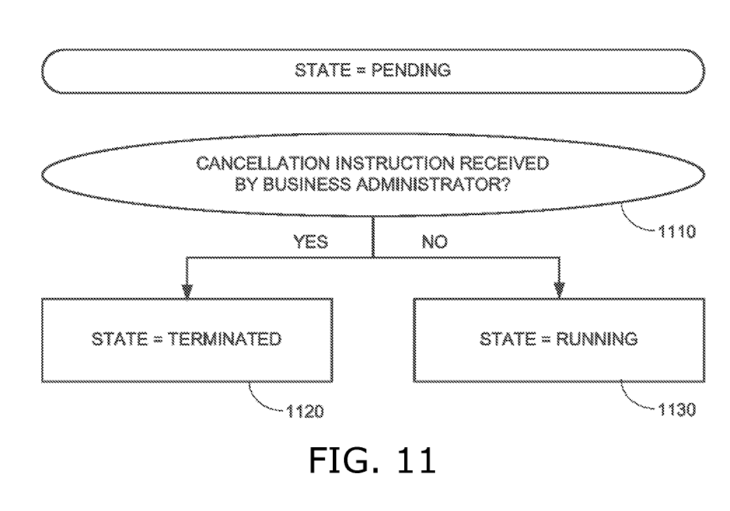

Reference is made to FIG. 11, which is a simplified flowchart of a method for a promotion that is in a PENDING state, in accordance with an embodiment of the present invention. At operation 1110 a determination is made whether or not a cancellation instruction is received by a business administrator in response to the alert message sent at operation 1010. If so, then at operation 1120 the state of the promotion evolves to TERMINATED. If not, then at operation 1130 the state of the promotion evolves to RUNNING.

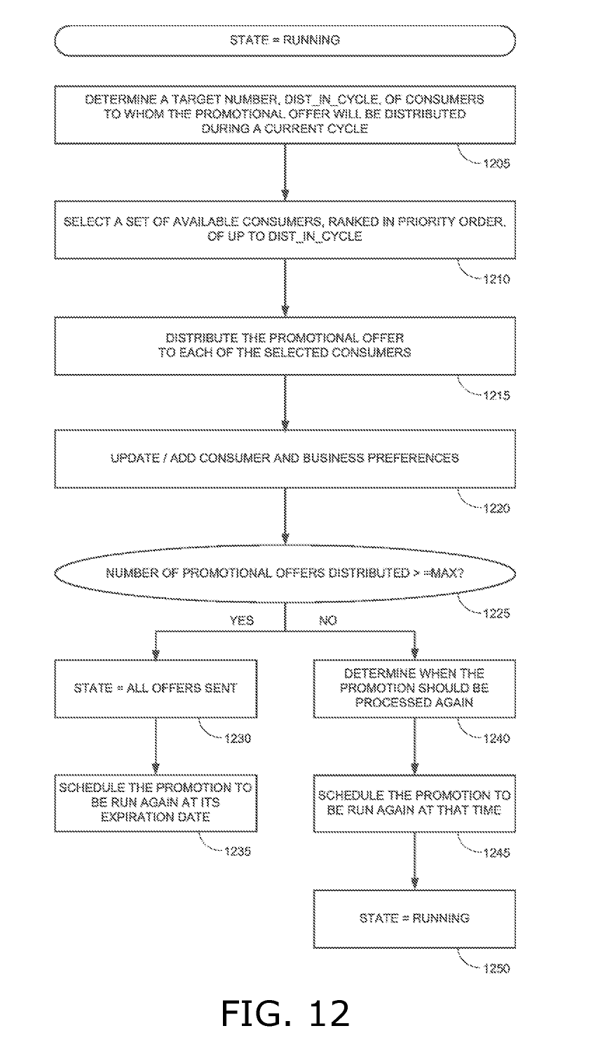

Reference is made to FIG. 12, which is a simplified flowchart of a method for a promotion that is in a RUNNING state, in accordance with an embodiment of the present invention. The promotion is processed by periodically distributing a cycle of promotional offers. At operation 1205 a target number of consumers is determined, denoted by DIST_IN_CYCLE, to whom promotional offers are to be sent during a current cycle. The target number DIST_IN_CYCLE is determined based inter alia on the maximum number of activations for the promotion, the number of activations already granted, and an historical response rate for the promotion.

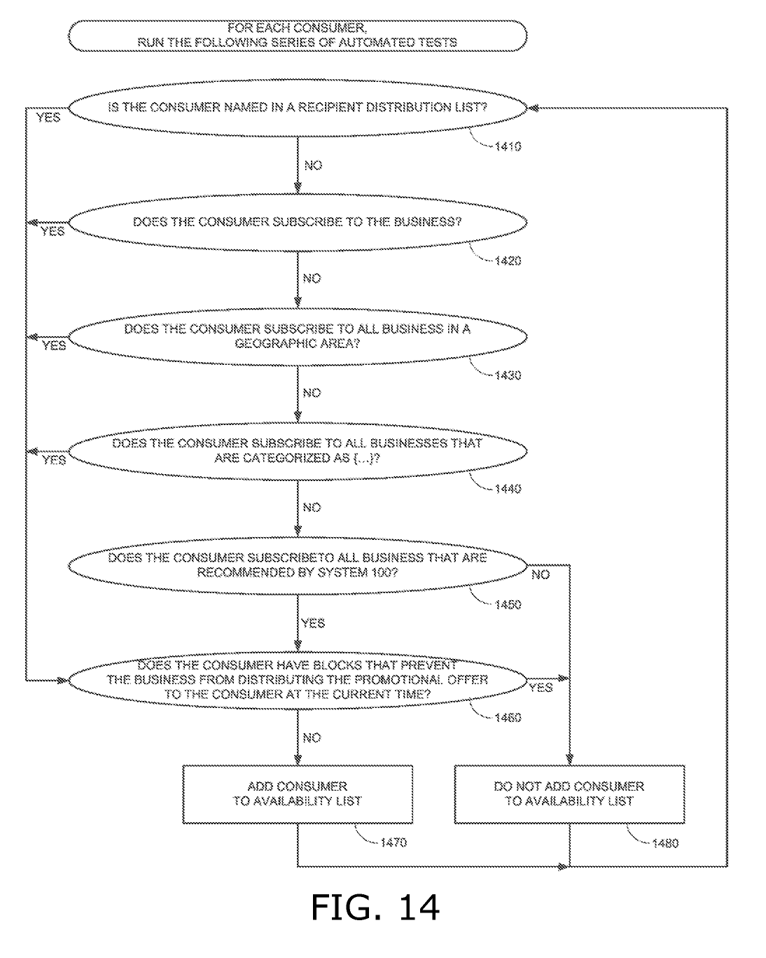

At operation 1210 a set of up to DIST_IN_CYCLE consumers are selected and ranked in priority order. Operation 1210 is described in detail below with reference to FIG. 14.

Reference is made to APPENDIX B, which is a listing of pseudo-code for ranking and selecting available consumers, in accordance with an embodiment of the present invention.

At operation 1215 a promotional offer is sent to each of the selected consumers. Operation 1215 includes dynamically composing text for the promotional offer based on system variables, and transmitting the promotional offer via the communication channel, such as SMS or e-mail, as specified by each consumer's preference.

At operation 1220 consumer preferences and promotional constraints are updated. E.g., a consumer preference that is a block for a designated number of days is generated for each consumer to whom the promotional offer was distributed. The block may be based on a designated preference for the number of promotional offers in aggregate to be received by a consumer in a designated time period.

At operation 1225 a determination is made whether the maximum number of promotional offers for the promotion have been distributed. If so, then at operation 1230 the state of the promotion evolves to ALL OFFERS SENT, and at operation 1235 the promotion is scheduled to be processed again at its expiration date. If not, then at operation 1240 a determination is made as to when the promotion should be processed again. Operation 1240 is based on inter alia historical response times, in order to give consumers time to reply and avoid distributing on average more offers than necessary to elicit a target number of activations. At operation 1245 the promotion is scheduled to be processed again at the time determined at operation 1240, and at step 1250 the state of the promotion is changed to RUNNING.

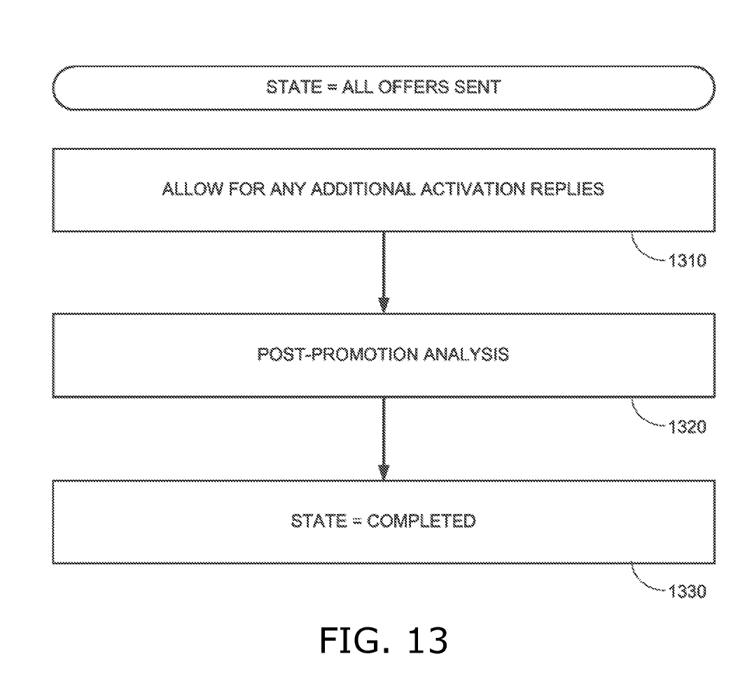

Reference is made to FIG. 13, which is a simplified flowchart of a method for a promotion that is in an ALL OFFERS SENT state, in accordance with an embodiment of the present invention. At operation 1310 additional activation replies are allowed for, in response to activation attempt events such as activation attempts at operation 250. At step 1320 a post-promotion analysis is performed, including updating the historical response rate for the promotion. Alternatively, step 1320 may be performed dynamically throughout operation of system 100. At step 1330 the state of the promotion evolves to COMPLETED.

Reference is made to FIG. 14, which is a simplified flowchart of a method for identifying available consumers to receive a promotional offer from a specific business, in accordance with an embodiment of the present invention. The flowchart of FIG. 14 is performed at operation 1210 of FIG. 12, and provides an overview of the more detailed pseudo-code listing in APPENDIX B. The flowchart of FIG. 14 generates an availability list by applying, for each consumer, a series of automated tests related to consumer preferences. At operation 1410 a determination is made whether the consumer is named in a recipient distribution list. For example, for an instant opt-in reward, a recipient distribution list includes one consumer. If so, the method advances to operation 1460. If not, then operation 1420 a determination is made whether the consumer subscribes to the business. If so, the method advances to operation 1460. If not, then at operation 1430 a determination is made whether the consumer subscribes to all businesses within a geographic area that includes the specific business. If so, the method advances to operation 1460. If not, then at operation 1440 a determination is made whether the consumer subscribes to all businesses that are recommended by system 100. If not, then at 1480 the consumer is not added to the availability list and the method returns to operation 1410 to process the next consumer. If so, then at operation 1470 a determination is made whether the consumer has a block that prevents the specific business from distributing the promotional offer to the consumer at the current time. If not, then at operation 1470 the consumer is added to the availability list and the method returns to operation 1410 to process the next consumer. If so, then at 1480 the consumer is not added to the availability list and the method returns to operation 1410 to process the next consumer.

Regarding operation 1470, a block that prevents the specific business from distributing the promotional offer to the consumer at the current time includes inter alia (i) a customer block, e.g., “no offers from the specific business until a future date”, “no offers from any business until a date in the future”; and (ii) a business block, e.g., “no offers to this consumer until a date in the future”.

After all consumers are processed, the method of FIG. 14 ends, and the availability list is then prioritized. Priority may be based inter alia upon business preferences and upon consumer preferences. Priority may also be based upon consumer status, including inter alia engagement points earned for loyalty, for providing feedback, and for referring friends; and premium or paid subscription.

### Operation 250

When a consumer receives a promotional offer via an SMS message, an e-mail message, or such other message, he may reply to the message. Upon reply, receiver 150 processes the incoming message to determine what type of message it is, for appropriate handling by system 100.

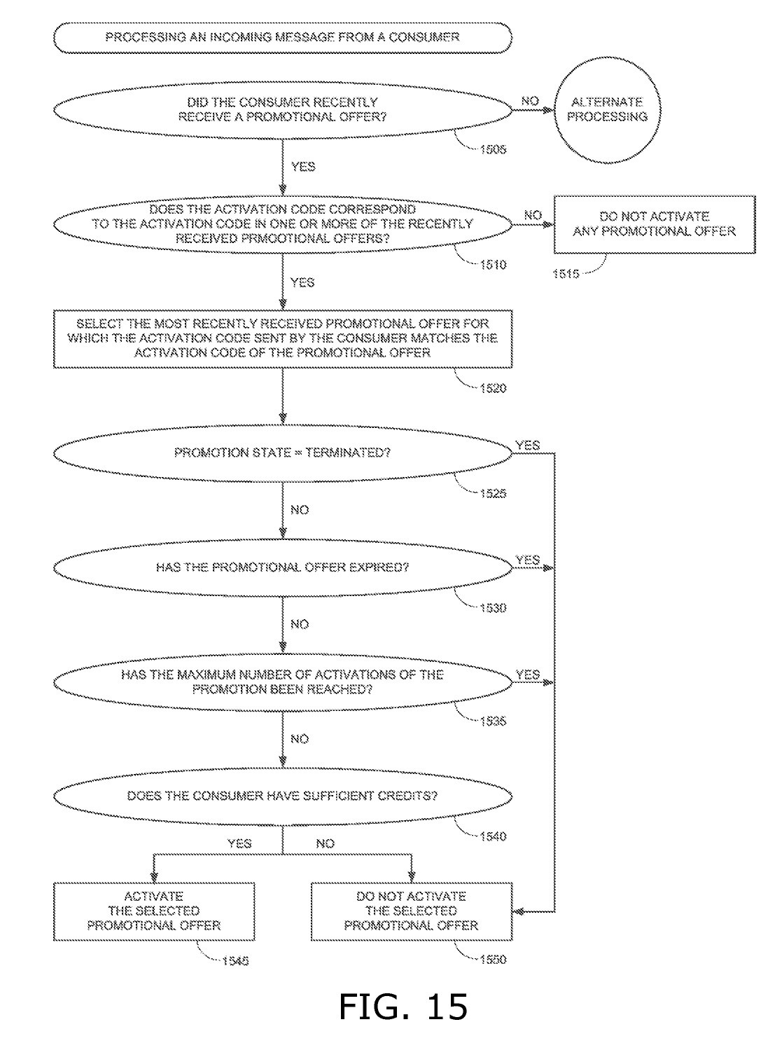

Reference is made to FIG. 15, which is a simplified flowchart of a method for processing an incoming message from a consumer, in accordance with an embodiment of the present invention. At operation 1505, a determination is made whether the consumer recently received a promotional offer. If not, then the message is processed with an alternate method. If the consumer did recently receive a promotional offer, then at operation 1510 a determination is made whether the activation code corresponds to the activation code in one or more recently received promotional offers. If not, then then at operation 1515 no promotional offer is activated. If so, then at operation 1520 the most recently received promotion offer, for which the activation code sent by the consumer matches the activation code of the promotional offer, is selected. At operation 1525 a determination is made whether the state of the promotion is TERMINATED. If so, then at operation 1550 the selected promotional offer is not activated. If not, then at operation 1530 a determination is made whether the promotional offer distributed to the consumer has expired. If so, then at operation 1550 the selected promotional offer is not activated. If not, then at operation 1535 a determination is made whether the maximum number of activations of the promotion has been reached. If so, then at operation 1550 the selected promotional offer is not activated. If not, then at operation 1540 a determination is made whether the consumer has sufficient credits with system 100 to activate the promotional offer, if the offer has a distribution constraint specifying an activation credit cost. If so, then at operation 1545 the selected promotional offer is activated, as described below. If not, then at operation 1550 the selected promotional offer is not activated.

If a promotional offer is not activated at operation 1550, an appropriate message may optionally be sent to the consumer, such as “sorry, you were too late”, or “the offer expired”, or “the offer expired, but come in instead for 10%.”

### Operation 260

When a promotional offer is activated at operation 1545 of FIG. 15, a reply message is sent to the consumer with a redemption code. The redemption code may be selected from a list of predetermined codes that were allocated to a promotion when it was originally scheduled. Alternatively, the redemption code may be a unique dynamically generated code. Redemption codes are subsequently used to identify which consumer received and activated which promotion.

When a promotional offer is activated, various data is updated, including inter alia a business constraint that determines if and when a consumer may receive more promotional offers, consumer data for engagement points, and consumer data for activation credits.

The present invention has broad application to promotional campaigns. Although the description above relates to relational database tables, it will be appreciated by those skilled in the art that other data structures may be used instead to represent the promotional offers and consumer preferences.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

TABLE I
Business Profile

| Field | Data Type | Description |
|---|---|---|
| Business Name | String | The common name of the business |
| Business ID | Int | Unique ID of the business, used to |
| | | reference the business within the |
| | | system |
| Promo Code | String | Unique promotion code used to |
| | | reference this business to consumers, |
| | | as an alternate to the Business Name. |
| | | E.g. “MYBAR” instead of the business |
| | | name “My Bar & Grill Downtown” |
| Address latitude | Double | The latitude of the business. |
| Address longitude | Double | The longitude of the business. |
| Engagement Point | Text | A set of globally unique Engagement |
| Codes | | Point codes and related points, |
| | | periodically generated and augmented |
| | | by System 100. E.g., |
| | | {“code”:”ABCDEF”; “points”:”50”; |
| | | “used?”:”false”} |
| | | {“code”:”123XYZ”; “points”:”20”; |
| | | “used?”:”true”} |
| | | These codes are provided to |
| | | consumers, e.g., a server can write a |
| | | code on a card as a replacement for a |
| | | typical loyalty-punch-card. Consumers |
| | | redeem the codes by sending a |
| | | command message to system 100, |
| | | enabling a convenient method to track |
| | | consumer engagement and to use this |
| | | information in promotional distribution |
| | | constraints. |

TABLE II
Business Administrator Information

| Field | Data Type | Description |
|---|---|---|
| Business ID | int | |
| Phone number | string | The phone number of an administrator |
| | | of the business. |
| E-mail address | string | |
| Receive promotion | bool | Whether or not to receive a daily |
| cancellation alerts? | | message such as “Promotions have |
| | | been scheduled today. Reply CANCEL |
| | | to this message to cancel all promotions |
| | | for today.” |
| Receive promotion | bool | Whether or not to receive a message |
| activation alerts? | | when a consumer responds to activate |
| | | a promotion, receiving a unique |
| | | redemption code to redeem the offer at |
| | | the business. |
| Password | String | Hash of the password to authenticate |
| | | the administrator |

TABLE III
Promotion Scheduling Constraints

| Field | Data Type | Description |
|---|---|---|
| Business ID | int | The business this constraint applies to |
| Constraint Name | String | What type of scheduling constraint |
| | | governing scheduling of promotions |
| | | is this? |
| Constraint Parameters | String | A set of key/value parameters stored |
| | | in a string. |

TABLE IV
Promotion

| Field | Data Type | Description |
|---|---|---|
| Business ID | int | The business this constraint applies to. |
| Promotion ID | int | An identifier for the promotion. |
| Promotional text | text | Promotion text that will be used to |
| | | compose a promotional message to |
| | | send to consumers. The text may |
| | | include variables that are replaced by |
| | | business-side interface 110. E.g., “Use |
| | | by {#when}”. Business-side interface |
| | | 110 replaces {#when} with the |
| | | expiration of the promotion, as |
| | | determined based on the promotion |
| | | settings. |
| Promotional | int | The dollar amount of the promotion; |
| dollar amount | | e.g., $50, for a “$20 off $50” |
| | | promotion. |
| Promotional | int | The discount amount of the promotion; |
| discount amount | | e.g., $20, for a “$20 off $50” |
| | | promotion. |
| Promotion type | int | Type of promotion; e.g., instant opt-in |
| | | promotion, or freeform promotion. |
| Activation Code | String | Code that a consumer replies with to |
| | | attempt to activate this promotion and |
| | | receive a redemption code. |
| Reply Message | String | Optional message to include with a |
| When Activated | | redemption code sent to consumers |
| | | who reply to activate a promotion and |
| | | are granted a redemption code. |
| Reply Message | String | Optional message to send to consumers |
| When Not | | who reply to activate a promotion and |
| Activated | | are not granted a redemption code. |
| Activations allowed | int | The maximum number of consumer |
| | | activations permitted for this |
| | | promotion. |
| Maximum consumer | int | The maximum number of consumers to |
| distribution list | | whom the promotion may be sent. |
| Expiration | int | The number of minutes this promotion |
| | | is valid for, from the time it is |
| | | transmitted; e.g., 1 day. |
| Scheduled for | DateTime | The date and time the promotion will |
| | | run, if scheduled in advance. |
| Running state | int | The status of the promotion, used by |
| | | system 100 to determine how to |
| | | process the promotion; e.g., send more |
| | | messages, terminate. |
| Pre-assigned | text | The activation code that this promotion |
| redemption | | may issue to consumers; e.g., |
| codes | | “ABCDEF, ZXYRDM”. |

TABLE V
Promotion Distribution Constraints

| Field | Data Type | Description |
|---|---|---|
| Promotion ID | int | The promotion this constraint applies to |
| Constraint Name | String | What type of distribution constraint |
| | | governing scheduling and distribution of |
| | | promotions is this? |
| Constraint | String | A set of key/value parameters stored |
| Parameters | | in a string. |

TABLE VI
Consumer Profile

| Field | Data Type | Description |
|---|---|---|
| Consumer ID | int | |
| Phone number | text | |
| E-mail address | text | |
| First Name | Text | |
| Last Name | Text | |
| Receive text | Bool | Whether or not the consumer wishes to |
| message | | receive promotional offers via SMS |
| promotions? | | messages. |
| Receive email | bool | Whether or not the consumer wishes to |
| promotions? | | receive promotional offers via e-mail |
| | | messages. |
| Password | String | Hash of password to authenticate |
| | | consumer |
| Activation Credits | Int | Number of credits the consumer has to |
| | | activate promotional offers. Credits can |
| | | be awarded for activity, or purchased |
| | | by the consumer. |

TABLE VII
Promotion Receipt Preferences

| Field | Data Type | Description |
|---|---|---|
| Consumer ID | int | The consumer that this preference |
| | | applies to. |
| Preference Name | String | What type of consumer preference |
| | | governing receipt of promotions is this? |
| Preference | String | A set of key/value parameters stored |
| Parameters | | in a string. |

TABLE VIII
System Messages

| Field | Data Type | Description |
|---|---|---|
| Consumer ID | int | The consumer that this message was |
| | | sent to, or received from |
| Business | Int | The business administrator that this |
| Administrator ID | | message was sent to, or received from |
| Promotion ID | Int | The promotion that this message |
| | | relates to. |
| Business ID | int | The business that this message relates |
| | | to |
| Event type | String | What type of event is this? E.g. a |
| | | Promotional Outbound Message, a |
| | | Promotional Reply Message, Consumer |
| | | Promotion Request, Consumer Opt In, |
| | | Consumer Redemption of Engagement |
| | | Points, Promotion Activation Attempt, |
| | | Promotion Redemption, Friend Referral |
| | | Opt-In, Purchased Points, FACEBOOK ® |
| | | Like, Twitter Message |
| Message body | String | What is the content of the message |
| | | sent |
| Created at | Datetime | The date and time when the message |
| | | was sent or received |
| Engagement | Int | How many engagement points/loyalty |
| Points | | credits did the consumer receive for this |
| | | event? Certain Promotion Distribution |
| | | Constraints reference an Aggregate |
| | | Engagement Point threshold for a |
| | | consumer, thereby segmenting |
| | | consumers based on their past |
| | | engagement activity to conditionally |
| | | receive promotional offers, such as |
| | | premium offers. |

### APPENDIX C

Internally generated events and externally generated events that may dynamically re-trigger scheduling and distribution of promotional offers, in accordance with an embodiment of the present invention.

| Event | Event origination/source | Description of actions taken/examples |
|---|---|---|
| Consumer | Consumer preferences may be | Scheduler is notified of a change to consumer |
| Preference | updated in numerous ways, | preferences, providing the opportunity inter |
| Changed | including inter alia originating | alia to: |
| | from a consumer interface, | Dynamically update distribution of |
| | receipt of a command | promotional offers that target the |
| | message, or as a result of a | consumer in question, for example to |
| | promotional message | cancel a promotion or change a recipient |
| | distribution such as receipt of a | list; and |
| | promotional offer. | Schedule additional promotional offers |
| | | targeting the given consumer through use |
| | | of promotional distribution constraints. |
| | | For example, send the consumer a |
| | | context aware offer such as an opt-in |
| | | bonus offer, an opt-out retention offer, a |
| | | friend-referred offer, an add-on or a |
| | | cross-promotion offer for a related |
| | | business or service. For example, the |
| | | consumer opts in to receive offers from a |
| | | masseuse and then receives an opt-in |
| | | offer to receive spa services from a |
| | | business located nearby. |
| Consumer | Based on a consumer's | Update promotional scheduling, distribution of |
| Promotional | interaction with system 100 as | additional promotional offers and business and |
| Interactions | it pertains to promotional | consumer preferences in response to the |
| | offers, including inter alia | consumer's engagement; e.g., update a |
| | activating a promotional offer, | business preference to include a consumer in a |
| | never attempting to activate a | preferred promotional offer bracket based on |
| | certain category of promotional | activating 10 deals, send consumers retention |
| | offer as determined by system | offers or premium offers if they are not |
| | 100, or activating a | engaging with promotions. |
| | promotional offer for a related | |
| | business or service. | |
| External | Received through transmitter, | Update promotional scheduling and/or |
| Transaction | acting as an API, from a third | distribute additional promotional offers in |
| or Point of | party system such as a Point of | response to events such as: |
| Sale Events | Sale system or a payment | A consumer having just made a purchase |
| | network. | at a given business. For example, a |
| | | consumer pays for dinner at a business at |
| | | 7:30pm, and is sent, in accordance with |
| | | their preferences and system 100, a |
| | | promotional offer recommended by |
| | | system 100 for 50% off movie tickets at |
| | | a movie theater located nearby; and |
| | | A Point of Sale system sends system 100 |
| | | a notification indicating that the business |
| | | is under 50% capacity on a weekend |
| | | night at 7pm, thereby changing a |
| | | business's financial goals to increase the |
| | | total dollar reward allowed for the current |
| | | date, and the prioritization on the current |
| | | date of promotional offers with the |
| | | highest historical consumer response rate, |
| | | and thereafter causing system 100 to |
| | | schedule the distribution of additional, |
| | | high efficacy promotional offers to fill |
| | | empty seats. |
| Geographic | Received and interpreted from | Update promotional scheduling and/or |
| events | a number of potential sources | distribute additional promotional offers in |
| | including inter alia a GPS | response to events such as: |
| | enabled mobile computing | A consumer is believed to be nearby to a |
| | device, inferred via a third | certain location, and system 100 |
| | party service such as a service | immediately schedules and sends him a |
| | allowing consumers to check-in | promotional offer for a nearby business; |
| | at a given location of interest, | and |
| | a consumer planning a trip | A consumer is anticipated to be going to a |
| | through a travel planning | certain location in the future, so system |
| | service to travel to a | 100 schedules promotional offers that |
| | destination, or as determined | target the timeframe and geography in |
| | internally based on a schedule | question based on consumer preferences |
| | input by the consumer of their | and system recommendations. |
| | home, work and other | |
| | addresses, and the schedule of | |
| | times they are present at each | |
| | address. | |
| Social | Received and interpreted from | Adjust distribution or distribute additional |
| network | a number of potential sources | promotional offers based on activities logged |
| events | including inter alia activity on | in system 100 by a consumer's social network/ |
| | system 100 filtered based on | friends, to target groups of friends with |
| | third party friend-network data | specific offers. |
| | to determine the activity of a | |
| | consumer's friends or friend- | |
| | cluster. | |

What is claimed is:

1. A method for managing distribution of business promotional offers by a server computer, comprising:
receiving, by a server computer, from each of a plurality of business, (i) one or more definitions for promotional offers, each definition comprising at least one distribution constraint, and (ii) one or more scheduling constraints;
receiving, by the server computer, from each of a plurality of consumers, a plurality of preferences for receiving promotional offers; and
deriving, by the server computer, a schedule for distributing specific promotional offers to specific consumers at specific dates and times, in accordance with the distribution constraints, the scheduling constraints and the consumer preferences.

2. The method of claim 1 further comprising:
transmitting the specific promotional offers to the consumers at the specific dates and times in accordance with the derived schedule;
receiving one or more communications from one or more specific consumers for activating respective one or more specific promotional offers transmitted thereto; and
further transmitting respective one or more redemption codes for the one or more specific promotional offers to the one or more specific consumers.

3. The method of claim 2 further comprising selecting the one or more redemption codes from a predetermined list of codes.

4. The method of claim 2 wherein the at least one distribution constraint comprises a limit on the number of redemption codes that may be transmitted to consumers during a designated time period.

5. The method of claim 4 wherein said further transmitting is performed according to the order in which the one or more activation communications were received, up to the limit on the number of redemption codes.

6. The method of claim 2 wherein the definitions for promotional offers comprise promotional redemption costs associated with transmitting redemption codes for promotional offers, wherein the scheduling constraints include financial goals, and wherein said deriving derives the schedule in accordance with the financial goals and the promotional redemption costs.

7. The method of claim 6 wherein the financial goals comprises a maximum aggregate allowed promotional redemption cost in a designated time period.

8. The method of claim 1 wherein the consumer preferences comprise a frequency of receipt of promotional offers from a designated business, or a venue of a designated business.

9. The method of claim 1 wherein the consumer preferences comprise a frequency of receipt of promotional offers in aggregate from all businesses.

10. A system for managed distribution of business promotional offers, comprising:
a business-side interface for enabling each of a plurality of businesses to submit (i) one or more definitions of promotional offers, each definition comprising at least one distribution constraint, and (ii) one or more scheduling constraints;
a consumer-side interface for enabling each of a plurality of consumers to submit preferences for receiving promotional offers;
a scheduler for deriving a schedule for distributing specific promotional offers to specific consumers at specific dates and times, in accordance with the distribution constraints, the scheduling constraints and the consumer preferences; and
an event handler for invoking said scheduler in response to submissions by business and by consumers processed respectively by said business-side interface and said consumer-side interface.

11. The system of claim 10 further comprising:
a transmitter for sending communications comprising promotional offers in accordance with the schedule derived by said scheduler; and
a receiver for receiving communications from one or more specific consumers for activating respective one or more specific promotional offers, from corresponding businesses, transmitted thereto.

12. The system of claim 11 wherein said transmitter employs a data transmission channel from the group consisting of a telephone channel, an SMS channel, and an Internet protocol channel.

13. The system of claim 11 wherein, in response to said receiver receiving from a consumer a communication comprising an activation request for a promotional offer from a corresponding business, (i) said event handler invokes said scheduler to derive an updated schedule, and (ii) said transmitter transmits a redemption code for the promotional offer to the consumer.

14. The system of claim 13 wherein consumer preferences comprise preferences for receiving promotional offers, and wherein, further in response to said receiver receiving from the consumer the communication comprising the activation request for a promotional offer from the corresponding business, said consumer-side interface updates information about the consumer's preferences for receiving promotional offers.

15. The system of claim 13 wherein, further in response to said receiver receiving from the consumer the communication comprising the activation request for a promotional offer from the corresponding business, said business-side interface updates the distribution constraints or the scheduling constraints of the business.

16. The system of claim 10 further comprising:
a receiver for receiving communications from one or more specific consumers requesting promotional offers; and
a transmitter for sending promotional offers to the one or more specific consumers on demand,
wherein said scheduler determines which promotional offers said transmitter should transmit.

17. The system of claim 10 wherein said event handler further invokes said scheduler to derive an updated schedule in response to being notified of one or more transactions made by respective one or more of the plurality of consumers with respective one or more third party transaction systems.

18. The system of claim 10 wherein said event handler further invokes said scheduler to derive an updated schedule in response to being notified of one or more current geographical locations of respective one or more of the plurality of consumers.

19. The system of claim 10 wherein said event handler further invokes said scheduler to derive an updated schedule in response to being notified of one or more actions performed by respective one or more of the plurality of consumers with respective one or more social networks.
